(19) United States
(12) Patent Application Publication
(10) Pub. No.: US 2009/0026168 A1
(43) Pub. Date: Jan. 29, 2009

(54) METHOD FOR MANUFACTURING A RIGID-FLEX CIRCUIT BOARD

(76) Inventors: Tzong-Woei Tsai, Chia-Yi Hsien (TW); Yu-Lun Lin, Taipei City (TW); Hung-En Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/958,286

(22) Filed: Dec. 17, 2007

(30) Foreign Application Priority Data
Jul. 26, 2007 (TW) 096127313
Nov. 20, 2007 (TW) 096143890

(51) Int. Cl. H01B 13/00

(52) U.S. Cl. 216/17

(57) ABSTRACT

A method for manufacturing a rigid-flex board is disclosed. After the formation of each layer of the rigid-flex board, a laser-etched groove is formed at the interface between a rigid part and a bending area of the rigid-flex board. After the laser etching process, a circuit-board routing process is performed to remove materials along the sideward perimeter of the bending area. The exposed copper layer is then removed from inside the laser-etched groove. Thereafter, a redundancy rigid structure within the bending area is readily removed to expose the flex board within the bending area.

### BACKGROUND OF THE INVENTION

1. Field of the Invention

The present invention relates to the field of printed circuit board (PCB) technology. More particularly, the present invention relates to a method for manufacturing a rigid-flex circuit board.

2. Description of the Prior Art

Rigid-flex printed circuit boards or rigid-flex boards are known in the art, which allow integrated interconnection between several rigid boards. This technology helps to reduce the number of soldered joints and plug-in connections and also the number of wires and cables, thus improving quality and reliability. For this reason, the rigid-flex board has become firmly established in many sectors of industry, notably automotive, telecommunications, medical, sensor technology, mechanical engineering and military electronics.

Typically, the fabrication of a rigid-flex board may start with a flex circuit board or flex board as core material. Rigid circuit board process such as build-up method or core-lamination method is then performed to form multi-layer circuit on the core flex board. Eventually, a redundancy rigid part that is directly above a pre-determined area to be bent is removed by a mechanical depth-controlled routing technique.

However, the prior art method for fabricating rigid-flex boards has shortcomings. Because of the difficulty of precise control of the routing depth, the aforesaid mechanical depth-controlled routing technique for removing the redundancy rigid part above a bending area may have potential risks of damaging the flex board, particularly at the interface between the flex and rigid parts. Further, expensive, custom-made fixtures or molds are ordinarily required in the mechanical depth-controlled routing process, thus increasing the production cost. The custom-made fixtures or molds are also time-consuming, which decreases the production throughput. Therefore, there is a strong need in this industry to provide an improved method for manufacturing rigid-flex boards in order to solve the above-mentioned problems.

### SUMMARY OF THE INVENTION

It is one object of the present invention to provide an improved method for manufacturing rigid-flex boards, particularly focusing on the improvement of the step of removing the redundancy rigid part above a bending area, thereby solve the above-mentioned prior art problems.

According to the claimed invention, a method for manufacturing rigid-flex board is provided. A flex board is provided. The flex board comprises an intermediate base layer and copper circuit pattern layers disposed on an upper side and bottom side of the intermediate base layer. A protective cover layer is laminated on the copper circuit pattern layers. A pre-routed dielectric layer is laminated on the protective cover layer, wherein the pre-routed dielectric layer comprises at least one pre-routed opening that defines a bending area between two rigid parts. A copper foil is laminated on the pre-routed dielectric layer. A rigid circuit board structure is formed within the rigid parts. Concurrently, the bending area is covered with at least one dielectric material. A first cutting process is performed to remove the dielectric material at the interface between the bending area and the rigid part, thereby forming a first groove exposing a portion of the copper foil. A second cutting process is performed to remove an extra, sideward rigid board and flex board at two opposite sides of the bending area. A copper etching process is performed to remove the exposed copper foil from inside the first groove, thereby forming a second groove connected to the pre-routed opening and a redundancy rigid structure within the bending area. The redundancy rigid structure within the bending area is then removed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-7 are schematic diagrams illustrating the method for manufacturing a rigid-flex board in accordance with one preferred embodiment of this invention, wherein FIGS. 1-3 and 5-7 are cross-sectional views of the rigid-flex board, while FIG. 4 is a schematic top view showing the rigid-flex board after performing a second cutting process.

### DETAILED DESCRIPTION

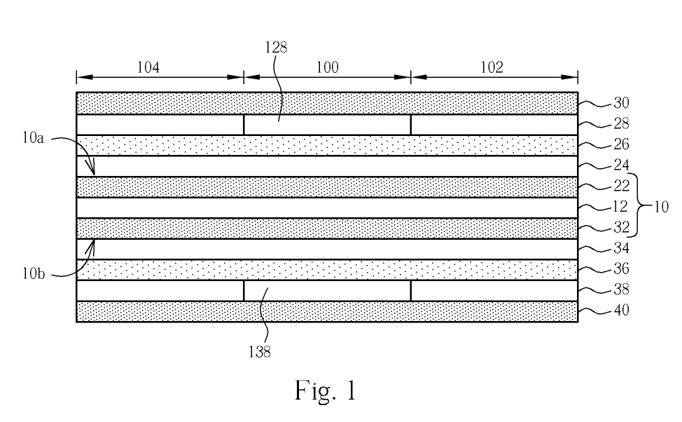

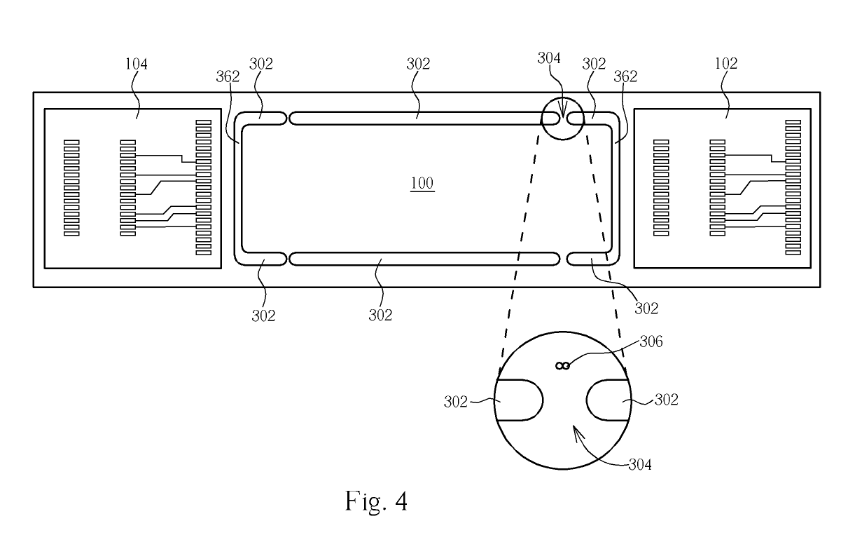

Please refer to FIGS. 1-7. FIGS. 1-7 are schematic diagrams illustrating the method for manufacturing a rigid-flex board in accordance with one preferred embodiment of this invention, wherein FIGS. 1-3 and 5-7 are cross-sectional views of the rigid-flex board, while FIG. 4 is a schematic top view showing the rigid-flex board after performing a second cutting process.

As shown in FIG. 1, a flex board 10 comprising an intermediate base layer 12, a copper circuit pattern layer 22 and a copper circuit pattern layer 32 is provided. The intermediate base layer 12 may be composed of dielectric materials. The dielectric materials may include but not limited to polyimide.

A protective cover layer 26 and a protective cover layer 36 are formed on the first side 10a and second side 10b of the flex board 10, respectively. The protective cover layers 26 and 36 may be composed of polyimide or any other suitable materials. The protective cover layers 26 and 36 protect the underlying copper circuit pattern layer 22 and copper circuit pattern layer 32 from the corrosion of etchant solution that is used during the fabrication of the rigid-flex board.

In addition, the protective cover layer 26 may be boned to the first side 10a of the flex board 10 by using an adhesive layer 24 and pressing methods, and the protective cover layer 36 may be boned to the second side 10b of the flex board 10 by using an adhesive layer 34 and pressing methods.

Subsequently, a pre-routed dielectric layer 28 and a pre-routed dielectric layer 38 such as low-flow prepreg (abbr. of pre-impregnated) are laminated on the protective cover layer 26 and the protective cover layer 36, respectively. Prepreg is the abbreviation of pre-impregnated fibers, which include but not limited to reinforcing glass fibers or other fibers pre-impregnated with a polymer matrix resin system that is typically incompletely cured (B-stage) thermosetting resin system.

The pre-routed dielectric layer 28 and the pre-routed dielectric layer 38 have an opening 128 and an opening 138, respectively. The position and area of the openings 128 and 138 in the pre-routed dielectric layer 28 and the pre-routed dielectric layer 38 are pre-determined and pre-routed according to the position and area of the bending area 100 between a rigid area 102 and a rigid area 104.

From one aspect, the dielectric layer 28 and 38 merely covers the rigid areas 102 and 104, while exposes the bending area 100. The pre-routed dielectric layers 28 and 38 may have a plurality of pre-routed openings.

Thereafter, a copper foil 30 and a copper foil 40 are laminated on the pre-routed dielectric layer 28 and the pre-routed dielectric layer 38 respectively.

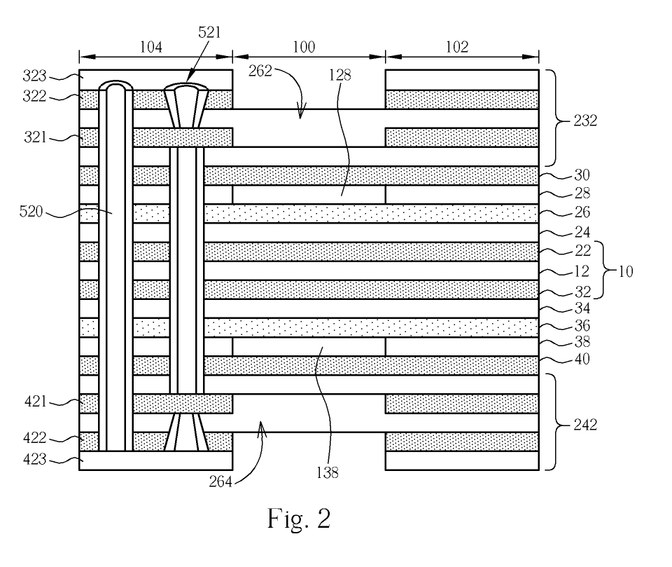

Subsequently, as shown in FIG. 2, circuit build-up process is carried out to form additive circuit layers on the copper foils 30 and 40 respectively. The involved intermediate process includes but not limited to plating, etching, through-hole or blind-via drilling and solder-resist coating. At this point, rigid board circuit structures 232 and 242 and plated through holes 520 and blind via 521 for electrically connecting circuit layers (including the flex board) are formed within the rigid areas 102 and 104 respectively. After the circuit build-up process, the bending area 100 is covered and filled with dielectric layers 262 and 264.

According to the preferred embodiment of this invention, the rigid board circuit structure 232 comprises a copper circuit layer 321, a copper circuit layer 322 and a solder resist layer 323. The rigid board circuit structure 242 comprises a copper circuit layer 421, a copper circuit layer 422 and a solder resist layer 423. However, it is understood that the rigid board circuit structures 232 and 242 may comprise only one single layer or may comprise a plurality of circuit layers.

At this point, the area within the bending area 100 and above the copper foils 30 and 40 is filled with dielectric material 262 and dielectric material 264 such as prepreg but not limited thereto.

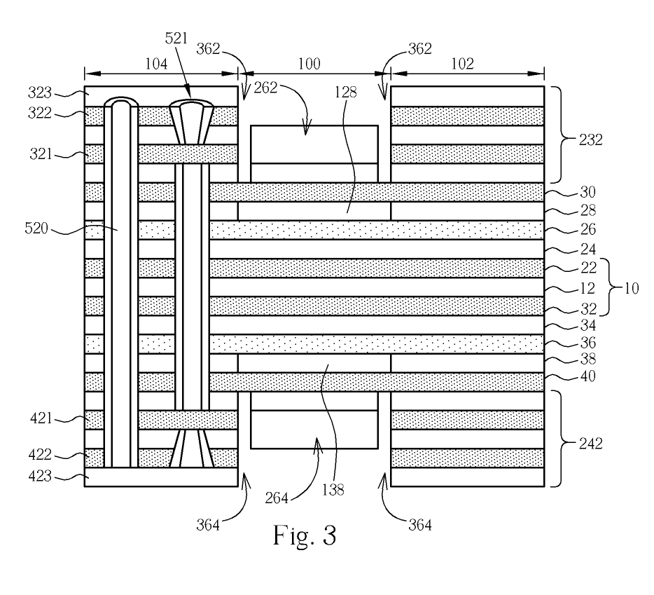

As shown in FIG. 3, a first cutting process, such as a laser cutting process that employs a laser beam with a pre-selected energy and wavelength, is carried out to remove a portion of the dielectric material 262 and a portion of the dielectric material 264 from the interface between the bending are 100 and the rigid area 102 and from the interface between the bending are 100 and the rigid area 104, thereby forming laser grooves 362 and 364 respectively.

As shown in FIG. 3, the laser grooves 362 and 364 expose a portion of the underlying copper foils 30 and 40 respectively. During the aforesaid first cutting process, the copper foils 30 and 40 protect the flex board 10 from laser-induced damage.

FIG. 4 is a schematic top view (not to scale) showing the rigid-flex board after performing a second cutting process. As shown in FIG. 4, a second cutting process is performed to remove an extra, sideward rigid board and flex board at two opposite sides of the bending area 100, thereby forming gap 302 traversing the thickness of the rigid board and flex board at two opposite sides of the bending area 100. The second cutting process may include mechanical routing methods or laser methods. The gap 302 is connected with the laser grooves 362 and 364.

As specifically indicated in FIG. 4, in accordance with the preferred embodiment of this invention, supporting bars 304 are provided for temporarily sustaining a redundancy rigid structure situated directly above the flex board 10 within the bending area 100. One of the supporting bars 304 is enlarged in the circle. Preferably, the supporting bars 304 are slender and thin such that they can be easily manually snapped off. According to the preferred embodiment, at least one explosion-proof aperture 306 is provided at one end of the supporting bar 304. However, it is understood that depending upon the design requirements, the explosion-proof aperture 306 may be omitted in other cases. The explosion-proof aperture 306 can prevent undesirable damage to the rigid-flex board during the removal of the redundancy rigid structure.

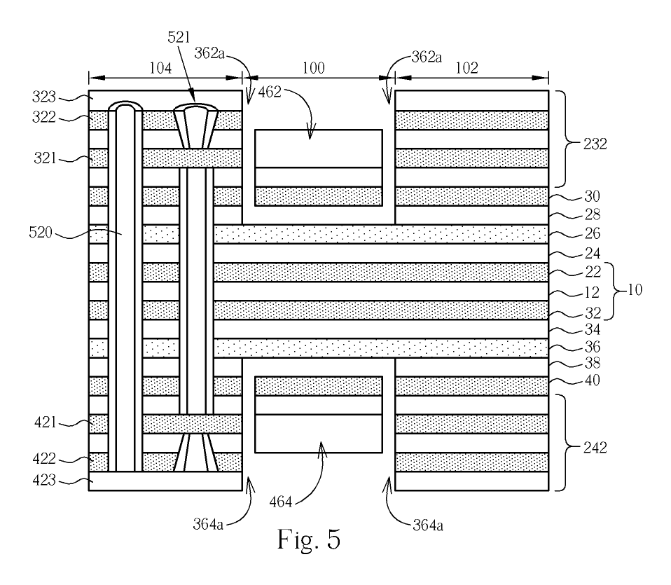

As shown in FIG. 5, after the second cutting process, a copper etching process is performed to remove the exposed copper foil 30 and copper foil 40 from inside the laser grooves 362 and 364, respectively, thereby forming a groove 362a connected to the opening 128 and a groove 364a connected to the opening 138. At this point, a redundancy rigid structure 462 and a redundancy rigid structure 464 to be removed are floating within the bending area 100. As previously mentioned, the redundancy rigid structures 462 and 464 are sustained through the supporting bars 304, which is not explicitly shown in FIG. 5, but shown in FIG. 4.

Further, according to this invention, the manufacturing sequence may be adjusted depending upon the process designs. For example, the second cutting process and the copper etching process may be swapped in another embodiment. The adjustment of the manufacturing sequence of the above-described process steps may increase the design flexibility. In addition, swapping the second cutting process and the copper etching process may have the advantage of omitting the step of manually removing the redundancy rigid structures.

In accordance with the preferred embodiment of this invention, the redundancy rigid structure 462 comprises dielectric material 262 and the copper foil 30 that is directly under the dielectric material 262. The redundancy rigid structure 464 comprises dielectric material 264 and the copper foil 40 that is directly under the dielectric material 264.

It is noteworthy that during the copper etching process, the inner-layer circuit formed on the flex board 10 is fully protected by the protective cover layers 26 and 36, thus avoiding the corrosion of etchant solution, which is one of the germane features of the present invention.

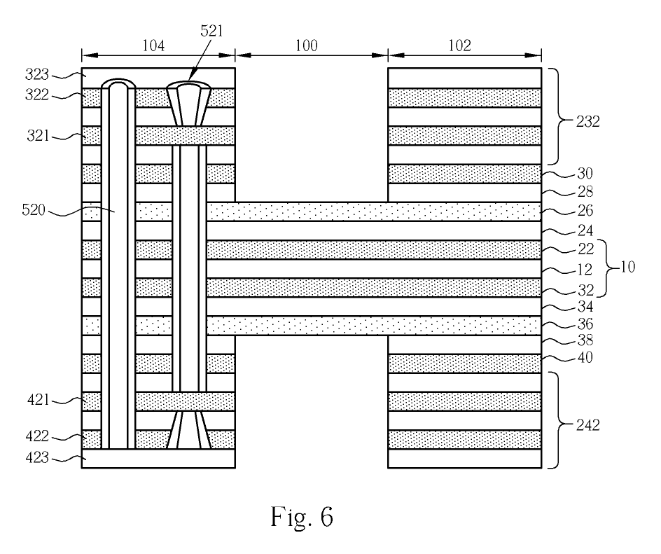

As shown in FIG. 6, subsequently, by snapping the supporting bars 304 with manual or any suitable physical methods, the redundancy rigid structures 462 and 464 are readily removed from the bending area 100, thereby exposing the flex board 10 within the bending area 100.

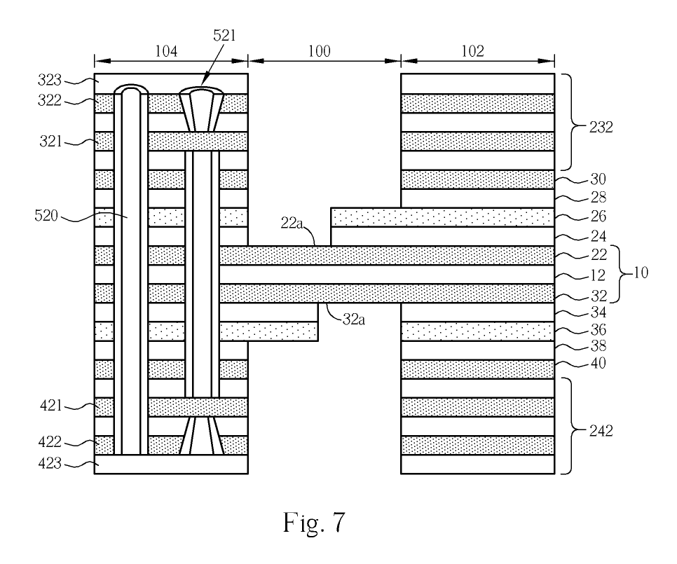

As shown in FIG. 7, optionally, after exposing the flex board 10 within the bending area 100, depending upon the customer's requirements, a portion of the protective cover layers 26 and 36 and the underlying adhesive layers 24 and 34 within the bending area 100 may be removed by laser methods, in order to expose a portion of the copper surfaces 22a and 32a on the flex board 10. Thereafter, for assembly purposes, surface treatments may be carried out on the exposed copper surfaces 22a and 32a on the flex board 10 within the bending area 100.

Those skilled in the art will readily observe that numerous modifications and alterations of the device and method may be made while retaining the teachings of the invention.

What is claimed is:

1. A method for manufacturing a rigid-flex board, comprising:
providing a flex board comprising an intermediate base layer and copper circuit pattern layers disposed on an upper side and bottom side of the intermediate base layer;
laminating a protective cover layer on the copper circuit pattern layers;
laminating a pre-routed dielectric layer on the protective cover layer, wherein the pre-routed dielectric layer comprises at least one pre-routed opening that defines a bending area between two rigid parts;
laminating a copper foil on the pre-routed dielectric layer;
forming a rigid circuit board structure within the rigid parts, concurrently, covering the bending area with at least one dielectric material;
performing a first cutting process to remove the dielectric material at the interface between the bending area and the rigid part, thereby forming a first groove exposing a portion of the copper foil;
performing a second cutting process to remove an extra, sideward rigid board and flex board at two opposite sides of the bending area;
performing a copper etching process to remove the exposed copper foil from inside the first groove, thereby forming a second groove connected to the pre-routed opening and a redundancy rigid structure within the bending area; and
removing the redundancy rigid structure within the bending area.

2. The method according to claim 1 wherein the intermediate base layer is composed of polyimide.

3. The method according to claim 1 wherein the protective cover layer is composed of resins.

4. The method according to claim 3 wherein the resins comprises polyimide.

5. The method according to claim 1 wherein the dielectric material comprises prepreg.

6. The method according to claim 1 wherein after the second cutting process, at least one supporting bar is provided at the perimeter of the bending area.

7. The method according to claim 6 wherein at least one explosion-proof aperture is provided at one end of the supporting bar.

8. The method according to claim 1 wherein after removing the redundancy rigid structure within the bending area, the method further comprises:
removing a portion of the protective cover layer within the bending area to expose a portion of the copper circuit pattern layers on the flex board.

9. The method according to claim 1 wherein the first cutting process is laser cutting process.

10. The method according to claim 1 wherein the second cutting process comprises mechanical routing process and laser routing process.

11. The method according to claim 10 wherein the second cutting process is mechanical routing process.
